(19) United States
(12) Patent Application Publication
(10) Pub. No.: US 2025/0178543 A1
(43) Pub. Date: Jun. 5, 2025

(54) SYSTEM AND METHOD FOR A SENSOR MOUNTING SYSTEM

(71) Applicant: TuSimple, Inc., SAN DIEGO, CA (US)

(72) Inventor: Christopher Luis HERNANDEZ, Tucson, AZ (US)

(21) Appl. No.: 18/960,915

(22) Filed: Nov. 26, 2024

Related U.S. Application Data
(60) Provisional application No. 63/605,099, filed on Dec. 1, 2023.

(51) Int. Cl. B60R 11/04; B60R 11/00

(52) U.S. Cl. CPC B60R 11/04; B60R 2011/004; B60R 2011/0052

(57) ABSTRACT

Provided herein a system and method for a bracket configured to position one or more sensors on a vehicle. A method for supporting a sensor on a vehicle includes: attaching an internal frame structure to an inside of a hood of a vehicle behind a grille supported by the hood; and attaching an external frame structure to the internal frame structure, where the external frame structure is positioned outside of the hood in front of the grille, where supports for the external frame structure extend through the grille and attach to the internal frame structure, where the external frame structure supports the one or more sensors at a position providing a line-of-sight not visible from inside a passenger compartment of the vehicle.

### CROSS-REFERENCE TO RELATED APPLICATIONS

This application claims priority to and the benefit of U.S. Provisional Application No. 63/605,099, filed on Dec. 1, 2023. The aforementioned application of which is incorporated herein in its entirety.

### TECHNOLOGICAL FIELD

An example embodiment of the present disclosure relates generally to the use of sensors for vehicle navigation and control, and more particularly, to a system and method for reliably and securely positioning one or more sensors on a vehicle.

### BACKGROUND

Autonomous and semi-autonomous vehicle control relies upon accurate digital maps and accurate understanding of the environment of a vehicle. A wide array of sensors are often used for autonomous and semi-autonomous vehicle control. Sensors that determine vehicle operating conditions, sensors that determine navigational directions, and sensors that identify the environment around the vehicle.

Maintaining the accuracy and effectiveness of sensors is critical to the proper function of the sensors, and to the information that the sensors provide to the vehicle for operation and for autonomous control. Positioning a sensor is not a trivial challenge, as sensors, particularly sensors relying on line-of-sight from the sensor, benefit from positioning that improves the field-of-view. Such positions can be vulnerable to impact damage from road debris and objects within an environment such that care must be exercised when positioning sensors on a vehicle.

Large vehicles conventionally have large “blind spots” for a driver or operator, and sensors can similarly have blind spots due to the size of the vehicle and a position of the sensors relative to the vehicle. Blind spots can be detrimental to vehicle operation such that it is desirable to minimize or eliminate blind spots.

### BRIEF SUMMARY

A system and method are therefore provided for positioning of one or more sensors on a vehicle. Embodiments of the present disclosure include a system for supporting one or more sensors on a vehicle including: an internal frame structure secured behind a grille of the vehicle to an inside of a hood supporting the grille; and an external frame structure positioned in front of the grille, outside of the hood supporting the grille and secured to the internal frame structure through the grille, where the external frame structure supports the one or more sensors at a position providing a line-of-sight not visible from inside a passenger compartment of the vehicle.

According to some embodiments, the internal frame structure is secured to the inside of the hood by at least one anchor point positioned above the grille and at least one anchor point positioned below the grille. The at least one anchor point positioned above the grille includes, in some embodiments, at least one upper bracket, where the at least one upper bracket is secured to the inside of the hood by an adhesive. The at least one anchor point positioned below the grill includes, in some embodiments, at least one lower bracket, where the at least one lower bracket is secured to the inside of the hood by an adhesive.

According to certain embodiments, the internal frame structure is secured to the inside of the hood by at least two anchor points positioned on either side of the grille. The internal frame structure of some embodiments provides increased rigidity to the hood of the vehicle. The internal frame structure of some embodiments includes at least one vertical member and at least one horizontal member, where the at least one vertical member and the at least one horizontal member are connected via a tab-and-slot connection. The internal frame structure of some embodiments further includes a weld bead between the at least one vertical member and the at least one horizontal member at the tab-and-slot connection.

The external frame support structure of some embodiments includes a rail extending horizontally across a front of the hood, where the one or more sensors are repositionable along a length of the rail. The one or more sensors of some embodiments include at least two LIDAR sensors and at least one camera. The one or more sensors of some embodiments further include at least two radar units. According to some embodiments, the at least two LIDAR sensors include a first LIDAR sensor positioned at a first end of the rail and a second LIDAR sensor positioned at a second end of the rail, opposite the first end. According to some embodiments, the at least one camera is positioned proximate a middle of the rail. The one or more sensors of some embodiments includes a center-mounted LIDAR positioned below the rail, where the center-mounted LIDAR defines a downwardly angled field-of-view. According to some embodiments, the center-mounted LIDAR is a short-range sensor. According to some embodiments, the first LIDAR sensor and the second LIDAR sensor are long-range LIDAR sensors.

Embodiments provided herein include a method for supporting a sensor on a vehicle, the method including: attaching an internal frame structure to an inside of a hood of a vehicle behind a grille supported by the hood; and attaching an external frame structure to the internal frame structure, where the external frame structure is positioned outside of the hood in front of the grille, where supports for the external frame structure extend through the grille and attach to the internal frame structure, where the external frame structure supports the one or more sensors at a position providing a line-of-sight not visible from inside a passenger compartment of the vehicle.

The method of some embodiments further includes: securing the internal frame structure to the inside of the hood by at least one anchor point positioned above the grille and at least one anchor point positioned below the grille, where the at least one anchor point positioned above the grille includes at least one upper bracket, where the at least one upper bracket is secured to the inside of the hood by an adhesive. The internal frame structure of some embodiments includes at least one vertical member and at least one horizontal member, where the at least one vertical member and the at least one horizontal member are connected via a tab-and-slot connection that is welded together. The external frame structure of some embodiments includes a rail extending horizontally across a front of the hood, where two or more LIDAR sensors and at least one camera are secured to the rail.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 illustrates a top-view of a vehicle including a system for reliably and securely positioning one or more sensors on a vehicle according to an example embodiment of the present disclosure;

FIG. 2 illustrates a side-view of a vehicle including a system for reliably and securely positioning one or more sensors on a vehicle according to an example embodiment of the present disclosure;

FIG. 3 illustrates a frontal perspective view of a sensor mounting system according to an example embodiment of the present disclosure;

FIG. 4 illustrates a rear perspective view of a sensor mounting system according to an example embodiment of the present disclosure;

FIG. 5 illustrates an internal frame structure for mounting within a hood of a vehicle according to an example embodiment of the present disclosure;

FIG. 6 illustrates an external frame structure for mounting within a hood of a vehicle according to an example embodiment of the present disclosure;

FIG. 7 illustrates an upper side mount for an internal frame structure according to an example embodiment of the present disclosure;

FIG. 8 illustrates a lower side mount for an internal frame structure according to an example embodiment of the present disclosure;

FIG. 9 illustrates a bottom mount for an internal frame structure according to an example embodiment of the present disclosure; and

FIG. 10 illustrates a top mount for an internal frame structure according to an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

Autonomous vehicle control, as described herein, includes vehicle control that is performed at least partially by a vehicle controller taking some responsibilities away from a human driver. Autonomous vehicle control can include semi-autonomous control, where certain functions are performed by a controller, while a human driver performs other functions, and fully-autonomous control, where a human driver is not necessary for control and navigation of the vehicle. Autonomous vehicle control, as described herein, includes this array of control possibilities such that the term “autonomous vehicle control” can include any degree of autonomous control ranging from minimal autonomy to fully autonomous.

Autonomous vehicle control is becoming more widely adopted, with increasing levels of autonomy becoming practical. Autonomous vehicle control is particularly beneficial for transport of goods, where such transport can occur at all hours of the day and for long distances. Although the systems and methods of example embodiments may be employed in conjunction with a variety of different types of autonomous vehicles, the systems and methods described herein will be described in conjunction with larger vehicles that tend to have significant blind spots such as trucks, tractor trailers, buses, or the like that are configured to operate autonomously by way of example, but not of limitation.

Vehicle sensors are often critical for operation of the vehicle. Sensors of conventional, manually-driven vehicles perform a wide range of functions, from wheel speed sensors, to rain detecting sensors, to parking sensors. Vehicles that have some degree of autonomy, whether it is adaptive cruise control, braking assist, steering assist, or total driverless autonomous control, require additional sensors, and many of these sensors are critical to the autonomous functionality of the vehicle. Sensor failures in vehicles can impair vehicle function, and when those sensors are critical to autonomous control, such sensor failure can require autonomous control to be relinquished to a human driver. It is critical to maintain vehicle sensor functionality. While certain sensors can function in a capacity-reduced state, other sensors are more sensitive to environmental conditions and adverse effects. Embodiments described herein provide a method and system for positioning vehicle sensors in an optimal position for functionality, while reducing blind spots and improving the overall effectiveness of the sensor suite of a vehicle.

While sensor positioning and functionality is important for all autonomous vehicles, it is particularly important for large vehicles. Roadways with traffic, urban corridors, and narrow streets or rural roads pose a greater challenge to large vehicles as there is less room for error in movement to avoid contact between the large vehicle and any elements of the environment. As such, positioning of certain sensors on a large vehicle is important to optimize functionality.

Sensors that require line-of-sight are particularly sensitive to position as they function best with a clear, broad range of vision. Cameras, radar, and light distancing and ranging (LIDAR) are examples of such line-of-sight sensors that benefit from optimized positions. While embodiments of the systems and methods described herein for positioning can be implemented with any of these line-of-sight reliant sensors, embodiments of the illustrated embodiment will herein be referenced with regard to LIDAR sensors, image sensors, radar modules, and the like that can be used to facilitate autonomous vehicle control.

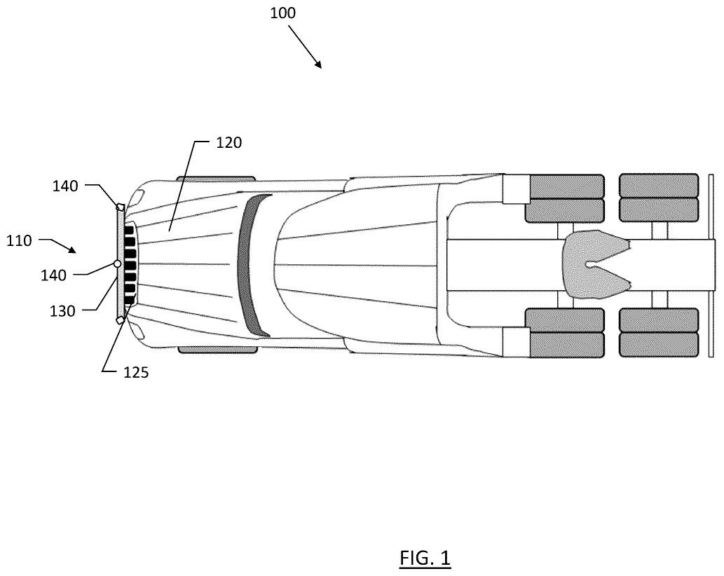

FIG. 1 illustrates a truck 100 having a front end 110. At the front end 110 of the truck is a hood 120, which in a conventional truck powered by an internal combustion engine, houses the engine. The illustrated embodiment depicts a conventional, long-nose truck common in the U.S.; however, embodiments described herein can be implemented in cab-over-engine or “COE” trucks such as those commonly found in Europe. At the front of the hood 120 is a grille 125, in front of which is an external frame structure 130 supporting one or more sensors 140.

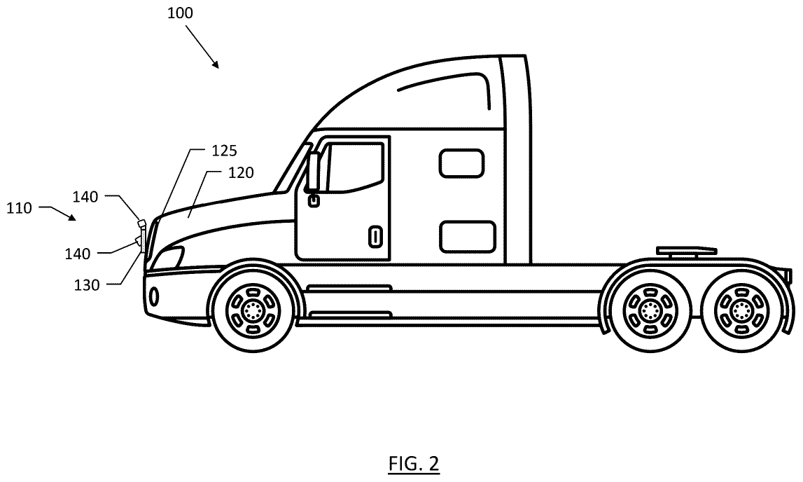

As will be described further below, the external frame structure 130 is supported by supports extending through the grille 125 and connected to an internal frame structure. This arrangement provides a forward-facing sensor mounting system that improves a field-of-view of the sensor array at the front end 110 of the vehicle. FIG. 2 illustrates a side profile view of the truck 100 of FIG. 1. As shown, the external frame structure 130 is mounted through a grille 125 at the front of the hood 120. Supporting the external frame structure through the grille enables the external frame structure 130 to be positioned at a height relative to the ground of between about 0.3 and 1.0 meters. This positioning of the external frame structure provides a mounting platform for various types, numbers, and configurations of sensors 140. Such positioning also enables sensor positioning in a manner that reduces blind spots and improves sensor visibility particularly in a forward direction which is the primary direction of travel of the vehicle.

The position of the external frame structure 130 is purposefully selected to provide optimal positioning options for sensors mounted to the external frame structure. Sensors 140 can be mounted in a variety of positions on the external frame structure 130 including more or fewer sensors to obtain a comprehensive view in front of and to the front-sides of the vehicle. Sensor positioning is generally forward biased (toward the front of the vehicle) as the primary direction of travel of the vehicle, particularly when using the sensors for autonomous control, is in the forward direction. Thus, the positioning of the sensors shown in FIGS. 1 and 2 are well-suited to autonomous vehicle control in the forward direction. Additional sensors may be required for autonomous control in the reverse direction such that the field-of-view behind the vehicle is covered. While not illustrated in the figures, other sensor brackets, and positioning mechanisms can be employed in other areas of the vehicle resembling those of the structure described at the front end 110 of the vehicle.

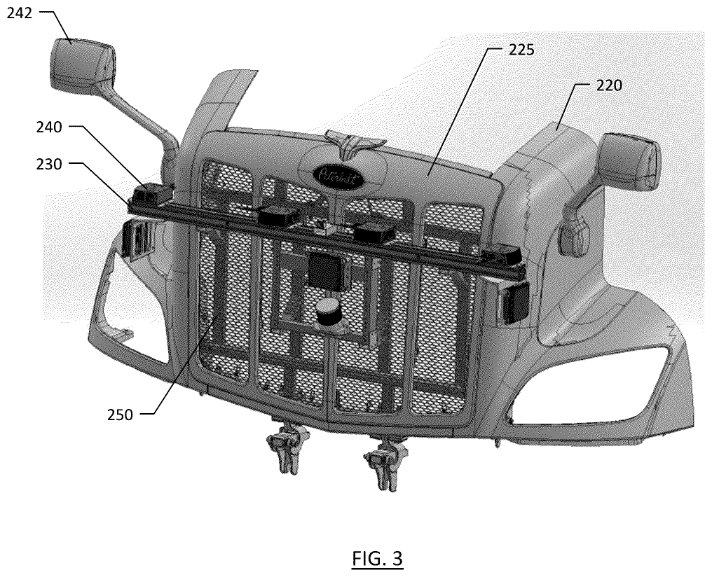

FIG. 3 illustrates a front perspective view of a front clip of a vehicle depicting the external frame structure 230 outside of the hood 220. Also visible is the internal frame structure 250 which will be described further below. The vehicle depicted in FIG. 3 is again a truck having an engine forward of a passenger compartment or cab, with a hood 220 extending forward of the cab. A portion of the hood 220 is depicted in FIG. 3 along with the grille 225. FIG. 3 provides an illustration of relative positioning of the external frame structure 230 to the hood 220 and the internal frame structure 250. According to the illustrated embodiment, hood-mounted mirrors 242 are mounted on an outside of the hood 220 and provide a rear view along the sides of the vehicle from the inside of the passenger compartment. These hood-mounted mirrors can include lighting, such as turn signal lighting or autonomous driving indicators that illuminate to provide an indication that the vehicle is under autonomous control. Such features may be mandated as autonomous vehicles become more ubiquitous.

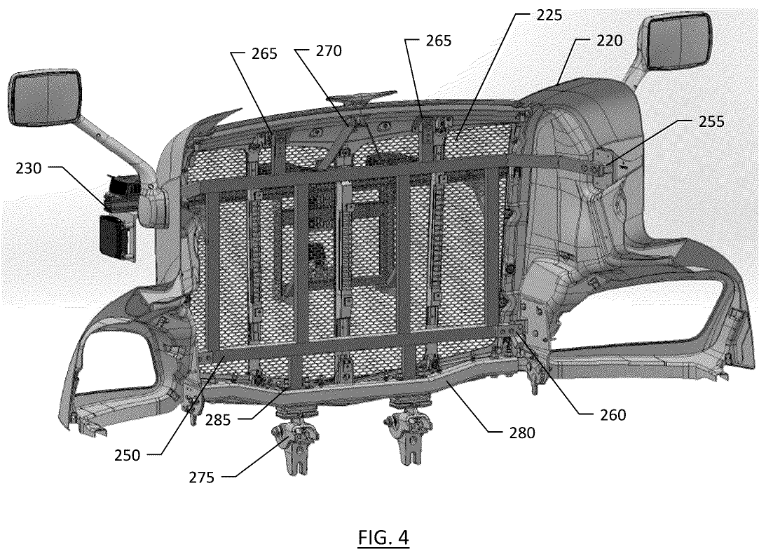

FIG. 4 illustrates a perspective view of a rear side of the front clip of the vehicle of FIG. 3 illustrating the internal frame structure 250 mounted inside of the hood 220 behind the grille 225. In a vehicle embodied by a class 8 truck, components are often made lightweight to aid fuel efficiency. The hood 220 that covers the engine in many front-engine trucks is made of fiberglass, composite, plastic, or the like. As such, the hood 220 often lacks substantial rigidity. Thus, mounting sensors to a hood can be problematic, as sensors such as image sensors and LIDAR are sensitive to vibrations which can occur in structures that lack rigidity when they experience vibrations, as is common in trucks traveling along a road segment, particularly if they employ diesel engines.

In order to mount sensors to a structure in a manner that has significant rigidity and stability in an environment that experiences substantial and sometimes unpredictable vibrations and harmonics, the sensors of example embodiments described herein are mounted in such a way as to have a direct connection to rigid structural members of the vehicle. A hood 220 of a front engine truck needs to open to provide open access to the very large engine concealed by the hood for regular and complete maintenance. As such, these hoods often pivot forward from a bottom forward position of the hood. Such a pivot point requires a secure mounting location to the vehicle, such that this location of a hood is often mounted, at least indirectly, to the frame or a sturdy structural member. FIG. 4 illustrates such hinges 275 which may be mounted to a frame of a vehicle. The hinges 275, in turn, must be mounted to a sturdy, rigid member of the hood 220. Hood lower cross member 280 provides that sturdy mounting point for the hinges 275 to provide a robust pivoting connection between the hood 220 and the vehicle. The lower cross member 280 is a structural member of the hood and serves as a mounting point for the internal frame structure 250 of example embodiments described herein.

As illustrated in FIG. 4, the internal frame structure 250 is secured at various points to the hood 220, beginning with the connection between the internal frame structure 250 bottom mount 285 to the lower cross member 280. The geometry of each connection will be discussed in greater detail below. The internal frame structure is further mounted on both sides of the hood at lower side mounts 260 and upper side mounts 255. An upper portion of the internal frame structure is mounted to upper brackets 265. Some embodiments further include upper central bracket 270 as will be described further below. This plurality of mounting points provides a substantially rigid internal frame structure 250 that is resilient to the many vibrations experienced proximate an engine of a front engine truck.

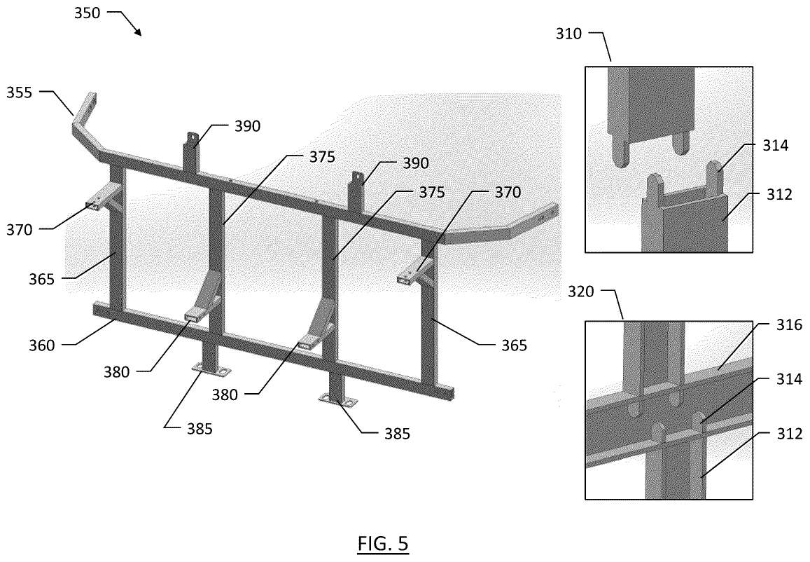

FIG. 5 illustrates the internal frame structure 350 of an example embodiment. The illustrated embodiment of the internal frame structure 350 includes an upper horizontal cross member 355 and a lower horizontal cross member 360. These horizontal cross members are secured on either end to brackets on the inside of the hood of a vehicle. Those brackets may be bonded to an inside of the hood, particularly in instances where the hood provides no suitable frame or structure to which the horizontal cross members can be more conventionally affixed, such as through a more basic bolt attachment. The internal frame structure 350 of FIG. 5 further includes vertical members including outer vertical members 365 and inner vertical members 375. The vertical members attach between the upper horizontal cross member 355 and the lower horizontal cross member 360. The upper horizontal cross member further includes a pair of upper braces 390 while the lower horizontal cross member includes a pair of lower braces 385.

The upper braces 380 can attach to upper brackets 265 as shown in FIG. 4, while the lower braces 385 can attach to bottom mounts 285. As noted above, the lower braces 385 mounted to a lower cross member 280 of the hood structure provides a sturdy attachment point for the internal frame structure 350. The further attachment of the opposing ends of the lower horizontal cross member 360 and the upper horizontal cross member 355, along with the attachment of the upper braces 390 ensures a complete mounting system that provides a structurally sound and vibration resistant foundation from which sensors can be mounted.

The connection points between the lower horizontal cross member 360 and the upper horizontal cross member 355 with the inner vertical members 375 and outer vertical members 365 can be achieved in a number of ways which may be dependent upon the material used for these members. However, embodiments described herein, each of the vertical members and horizontal members may be made of box channel, such as an aluminum box channel that includes two pairs of opposed, parallel sides. To connect these channels, the interface may include, for example, tabs and slots. The vertical members may be machined to have one or more tabs protruding from each end, while the horizontal members may include corresponding one or more slots machined therein configured to receive a respective tab. This tab-and-slot arrangement can be beneficial for a variety of reasons. The tabs and slots provide positive alignment and relative positioning between the horizontal members and the vertical members. Further, the tabs and slots enable quick and easy assembly of the components. The tabs and slots themselves do not provide a permanent fastener, such that the vertical members, where they meet the horizontal members, may be welded. The tabs and slots provide for alignment and enable a weld to be completed without displacing the vertical member relative to the horizontal member.

FIG. 5 includes two detail views of tab-and-slot arrangements including view 310 which depicts channels 312 having tabs 314 extending therefrom. View 320 illustrates a cross section of joined channels, where the tabs 314 are engaged within slots of the horizontal member 316 to provide positive locating means.

FIG. 5 further illustrates support brackets used to support the external frame structure through the grille of the vehicle. As shown in FIG. 5, the outer vertical members 365 each include an upper support bracket 370, while the inner vertical members 375 each include a lower support bracket 380. The upper support brackets 370 and the lower support brackets 380 extend forward of the internal frame structure 350 such that they protrude through a grille of the hood to which the internal frame structure is attached.

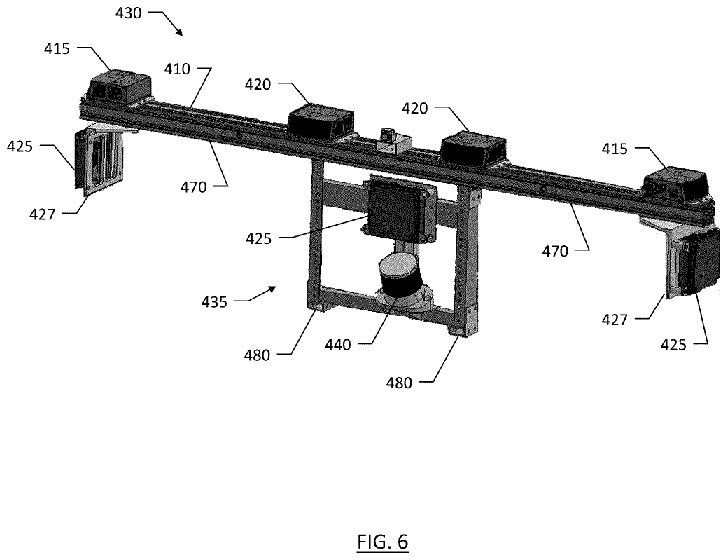

FIG. 6 illustrates an example of an external frame structure 430 that can be attached to the upper support brackets 370 and the lower support brackets 380 shown in FIG. 5. The external frame structure 430 of the illustrated embodiment is a reconfigurable platform for sensor mounting. As such, the horizontal cross member 410 of the external frame structure 430 of the illustrated embodiment comprises a rail having channels therein, such as an aluminum 80/20 T-slot extrusion. While any such rail can be employed, a T-slot extrusion provides infinite variability along the length for solid mounting positions. A lower portion 435 of the external frame structure 430 extends below the horizontal cross member 410 to provide a lower mounting point for different types of sensors.

According to the illustrated embodiment of FIG. 6, the external frame structure 430 supports a sensor array generally employed for forward-facing or at least partially forward-facing sensors. As described above, autonomous vehicle control relies upon the accuracy of sensors to enable proper functionality. Accuracy requires a field of view that is relatively unimpeded. Further, sensors are generally employed in redundant fashion to enable an autonomous system to achieve a high level of confidence through identifying objects and features of an environment through more than one sensor. This provides a robust system through which the autonomous functionality of the vehicle can operate with confidence. To achieve this high level of confidence, a sensor array may be employed that has sufficient redundancy and a thorough view of the environment.

The illustrated embodiment of FIG. 6 includes a plurality of LIDAR sensors, such as side-facing LIDAR sensors 415 and forward-facing LIDAR sensors 420. The forward facing and side facing LIDAR sensors have a field of view that extends such that the forward facing and side facing fields of view partially overlap to ensure there is no area forward of the vehicle that is not swept. As noted above, sensor redundancy and supplementation through different types of sensors benefits the autonomous vehicle control system through confidence of operation. The illustrated embodiment of FIG. 6 further includes radar sensors 425. These radar sensors are mounted in such a way as to have two side-facing radar sensors and a forward-facing radar sensors. These radar sensors provide supplemental environment data that reinforces or contradicts the LIDAR data from the LIDAR sensors. The side-facing radar sensors of the illustrated embodiment include suspended brackets 427 that support the radar sensors below the horizontal cross member 410, and arranges the sensor such that the field of view of the sensor is in the proper plane.

According to the illustrated embodiment, the lower portion 435 of the external frame structure 430 extending below the horizontal cross member 410 provides an improved position for the center-mounted radar sensor along with a short-range LIDAR sensor 440. Referring back to FIG. 3, the position of the external frame structure enables the lower portion shown in FIG. 6 to extend to a position that is relatively low but is maintained above a bumper of the vehicle thereby maintaining the sensors in a lower vulnerability area. In large vehicles such as class 8 trucks, and particularly those that are front engine, there is a blind spot directly in front of the vehicle, blocked from view of the driver by the hood, whose position and size are necessitated by the engine. The external frame structure 430 and the lower portion 435 thereof provide an ideal position for a short range LIDAR sensor 440 which includes a field of view across the forward blind spot of the vehicle. This enables a vehicle to be operated with lower risk than a conventional driver's field of view would allow.

According to the internal frame structure 350 of FIG. 5, the upper support brackets 370 would support the upper cross member 410 of the external frame structure 430 at positions 470. The lower support brackets 380 would support the lower portion 435 of the external frame structure 430 at positions 480. This arrangement would provide a strong and stable connection between the external frame structure 430 and the internal frame structure 450.

The internal frame structure 350 adds rigidity to the hood of the vehicle, while providing a rigid mounting base for the sensor array via the external frame structure 430. To achieve the stability of this structure, the internal frame structure requires robust mounting points to the hood itself. This is challenging in a front engine class 8 truck where the hood is typically designed to be light weight with minimal structure to reduce the overall weight of the vehicle, and to provide a movable hood that provides access to the engine for maintenance. Embodiments described herein achieve a rigid internal frame structure 350 through the implementation of mounting brackets or mounts within the hood to which the internal frame structure can be secured. FIG. 4 illustrates these mounting brackets which will be described herein more fully.

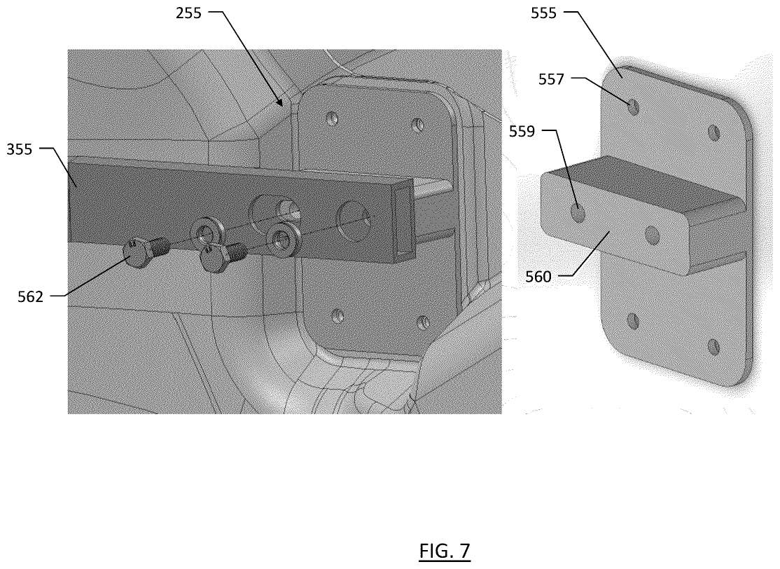

As shown in FIG. 4, the upper horizontal cross member (355 in FIG. 5) is attached at either end to upper side mounts 255. FIG. 7 illustrates a detail view of an upper side mount 255 and the bracket 555 that is mounted to the inside of the hood. According to the illustrated embodiment, the bracket 555 is formed of a relatively light weight but rigid material, such as 6061-T6 aluminum. The bracket 555 of the illustrated embodiment is positioned in a location inside of the hood that is opposite to where the hood mounted mirror (242 in FIG. 3) is attached. The bracket 555 includes through holes 557 in locations corresponding to the bolt holes of the hood mounted mirror attachment, such that the bracket 555 can be mounted to the hood using bolts received through the hood mounted mirror attachment. This arrangement sandwiches the hood itself between the bracket 555 and the hood mounted mirror bracket. The hood mounted mirror bracket is mounted to a reinforced position on the hood, such that securing the bracket 555 in this manner provides a strong and resilient mounting point for the upper horizontal cross member.

The bracket 555 includes a protrusion 560 that stands proud of the bracket portion that attaches to the hood to provide a mounting point for the upper horizontal cross member. The protrusion 560 includes threaded holes 559. The upper horizontal cross member 355 is secured to the protrusion 560 of the bracket 555 with bolts 562 as shown in FIG. 7. This secures the upper horizontal cross member 355 on both sides to secure locations within the hood.

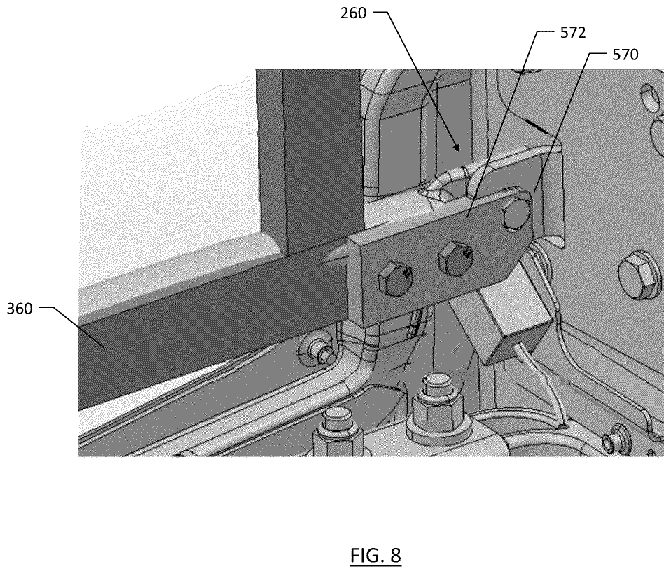

FIG. 8 illustrates a detail view of side mounts 260 shown in FIG. 4. As shown, the lower horizontal cross member 360 is secured to a bracket 570 that is part of the lower superstructure of the hood, thereby providing a secure mounting location for the lower horizontal cross member. A bracket 572 is provided to secure the lower horizontal cross member 360 to the bracket 570 using fasteners, such as bolts.

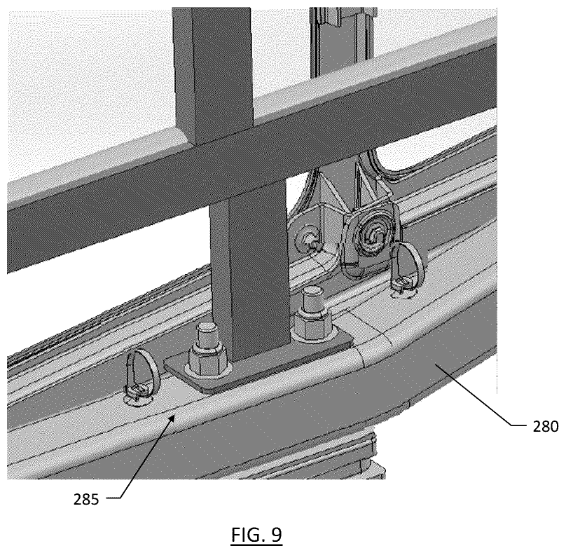

FIG. 9 illustrates a detail view of the bottom mount 285, where the bottom mount is secured to the lower cross member 280 of the hood structure. As noted above, the lower cross member 280 is securely and hingedly attached to a structural member of the vehicle, such as a frame member either directly or indirectly. As such, the lower cross member 280 provides a secure location on which to attach the bottom mount. As shown, the bottom mount 285 is bolted to the lower cross member 280.

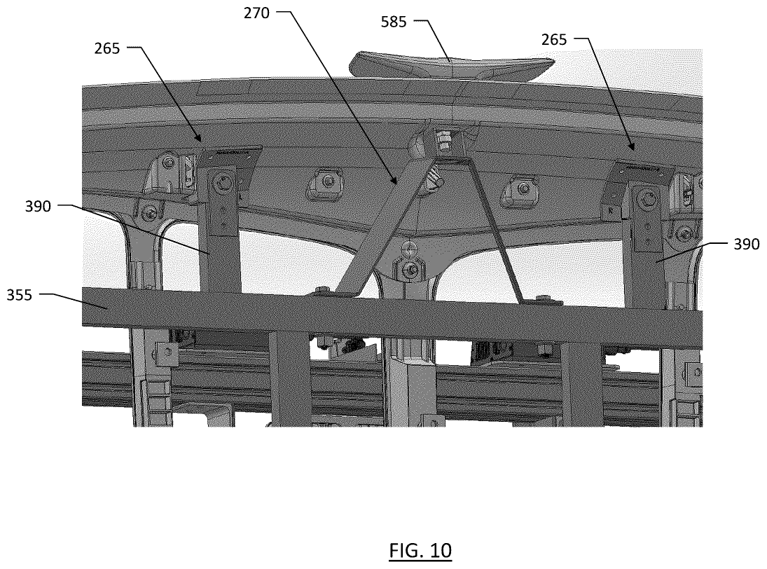

FIG. 10 illustrates the upper brackets 265 and the upper central bracket 270 of FIG. 4 in detail. As shown, the upper brackets 265 attach to the upper braces 290 shown in FIG. 5. The inside of the hood structure above the grille does not have substantial structural integrity and does not have any supporting superstructure. As such, the upper brackets 265 are bonded to the hood, which may be fiberglass, plastic, or composite, using an adhesive. The adhesive may be any type of adhesive that is compatible with the material of the upper brackets 265 and the inside of the hood to create a sufficient bond. The upper brackets 265 include a contoured surface to correspond to contours of the upper front portion of the hood above the grille. Further, the upper brackets 265 have sufficient surface area to provide a solid bond between the upper brackets and the hood using the adhesive to create a strong attachment point. Once the upper brackets 265 are secure to the hood, the upper braces 390 are bolted to the upper brackets 265 to create an upper support for the internal frame structure. Also shown is the upper central bracket 270 which bolts to the upper horizontal cross member 355 and bolts to the hood, such as using a bolt through which the hood ornament 585 is attached. The hood ornament 585 is often used as a handle to help operate the hood (i.e., moving the hood to an open position) such that the hood ornament 585 is secured to the hood at a reinforced position. This provides a sturdy point at which the upper central bracket 270 can be attached.

Embodiments described above provide a robust inner frame structure securely fastened within a hood of a vehicle behind a grille, whereby the inner frame structure is supported, at least indirectly, by a structural member of the vehicle. The mounting brackets within the hood provide a plurality of contact points between the inner frame structure and the hood to reinforce the strength and stability of the inner frame structure. The external frame structure, supported by supports extending from the internal frame structure, provides a versatile mount platform for a variety of sensor types in almost limitless configurations. Embodiments are ideal for test bed applications to permit sensors of various types, sizes, and capabilities to be mounted to the external frame structure in such a way that they have a field of view that is ideally suited to autonomous vehicle control, particularly on large vehicles such as class 8 trucks. This arrangement of sensors enabled by embodiments described herein provides an improved system for sensor data gathering during autonomous vehicle control, thus resulting in improvements to reliability, performance, and safety.

Clause 1. A system for supporting one or more sensors on a vehicle comprising:
an internal frame structure secured behind a grille of the vehicle to an inside of a hood supporting the grille; and
an external frame structure positioned in front of the grille outside of the hood supporting the grille and secured to the internal frame structure through the grille,
wherein the external frame structure supports the one or more sensors at a position providing a line-of-sight not visible from inside a passenger compartment of the vehicle.

Clause 2. The system according to Clause 1, wherein the internal frame structure is secured to the inside of the hood by at least one anchor point positioned above the grille and at least one anchor point positioned below the grille.

Clause 3. The system according to Clause 2, wherein the at least one anchor point positioned above the grille comprises at least one upper bracket, wherein the at least one upper bracket is secured to the inside of the hood by an adhesive.

Clause 4. The system according to Clause 3, wherein the at least one anchor point positioned below the grille comprises at least one lower bracket, wherein the at least one lower bracket is secured to the inside of the hood by an adhesive.

Clause 5. The system according to Clause 4, wherein the internal frame structure is secured to the inside of the hood by at least two anchor points positioned on either side of the grille.

Clause 6. The system according to Clause 5, wherein the internal frame structure provides greater rigidity to the hood of the vehicle.

Clause 7. The system according to Clause 1, wherein the internal frame structure comprises at least one vertical member and at least one horizontal member, wherein the at least one vertical member and the at least one horizontal member are connected via a tab-and-slot connection.

Clause 8. The system according to Clause 7, wherein the internal frame structure further comprises a weld bead between the at least one vertical member and the at least one horizontal member at the tab-and-slot connection.

Clause 9. The system according to Clause 1, wherein the external frame support structure comprises a rail extending horizontally across a front of the hood, wherein the one or more sensors are repositionable along a length of the rail.

Clause 10. The system according to Clause 9, wherein the one or more sensors comprise at least two LIDAR sensors and at least one camera.

Clause 11. The system according to Clause 10, wherein the one or more sensors further comprise at least two radar units.

Clause 12. The system according to Clause 10, wherein the at least two LIDAR sensors include a first LIDAR sensor positioned at a first end of the rail and a second LIDAR sensor positioned at a second end of the rail, opposite the first end.

Clause 13. The system according to Clause 12, wherein the at least one camera is positioned proximate a middle of the rail.

Clause 14. The system according to Clause 12, wherein the one or more sensors further comprise a center-mounted LIDAR positioned below the rail, wherein the center-mounted LIDAR defines a downwardly angled field-of-view.

Clause 15. The system according to Clause 14, wherein the center-mounted LIDAR is a short-range LIDAR sensor.

Clause 16. The system according to Clause 15, wherein the first LIDAR sensor and the second LIDAR sensor are long-range LIDAR sensors.

Clause 17. A method for supporting a sensor on a vehicle comprising:
attaching an internal frame structure to an inside of a hood behind a grille supported by the hood; and
attaching an external frame structure to the internal frame structure, where the external frame structure is positioned outside of the hood in front of the grille, wherein supports for the external frame structure extend through the grille and attach to the internal frame structure,
wherein the external frame structure supports the one or more sensors at a position providing a line-of-sight not visible from inside a passenger compartment of the vehicle.

Clause 18. The method according to Clause 17, further comprising:
securing the internal frame structure to the inside of the hood by at least one anchor point positioned above the grille and at least one anchor point positioned below the grille.
wherein the at least one anchor point positioned above the grille comprises at least one upper bracket, wherein the at least one upper bracket is secured to the inside of the hood by an adhesive.

Clause 19. The method according to Clause 17, wherein the internal frame structure comprises at least one vertical member and at least one horizontal member, wherein the at least one vertical member and the at least one horizontal member are connected via a tab-and-slot connection that is welded together.

Clause 20. The method according to Clause 17, wherein the external frame structure includes a rail extending horizontally across a front of the hood, wherein two or more LIDAR sensors and at least one camera are secured to the rail.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A system for supporting one or more sensors on a vehicle comprising:
an internal frame structure secured behind a grille of the vehicle to an inside of a hood supporting the grille; and
an external frame structure positioned in front of the grille outside of the hood supporting the grille and secured to the internal frame structure through the grille,
wherein the external frame structure supports the one or more sensors at a position providing a line-of-sight not visible from inside a passenger compartment of the vehicle.

2. The system according to claim 1, wherein the internal frame structure is secured to the inside of the hood by at least one anchor point positioned above the grille and at least one anchor point positioned below the grille.

3. The system according to claim 2, wherein the at least one anchor point positioned above the grille comprises at least one upper bracket, wherein the at least one upper bracket is secured to the inside of the hood by an adhesive.

4. The system according to claim 3, wherein the at least one anchor point positioned below the grille comprises at least one lower bracket, wherein the at least one lower bracket is secured to the inside of the hood by an adhesive.

5. The system according to claim 4, wherein the internal frame structure is secured to the inside of the hood by at least two anchor points positioned on either side of the grille.

6. The system according to claim 5, wherein the internal frame structure provides greater rigidity to the hood of the vehicle.

7. The system according to claim 1, wherein the internal frame structure comprises at least one vertical member and at least one horizontal member, wherein the at least one vertical member and the at least one horizontal member are connected via a tab-and-slot connection.

8. The system according to claim 7, wherein the internal frame structure further comprises a weld bead between the at least one vertical member and the at least one horizontal member at the tab-and-slot connection.

9. The system according to claim 1, wherein the external frame support structure comprises a rail extending horizontally across a front of the hood, wherein the one or more sensors are repositionable along a length of the rail.

10. The system according to claim 9, wherein the one or more sensors comprise at least two LIDAR sensors and at least one camera.

11. The system according to claim 10, wherein the one or more sensors further comprise at least two radar units.

12. The system according to claim 10, wherein the at least two LIDAR sensors include a first LIDAR sensor positioned at a first end of the rail and a second LIDAR sensor positioned at a second end of the rail, opposite the first end.

13. The system according to claim 12, wherein the at least one camera is positioned proximate a middle of the rail.

14. The system according to claim 12, wherein the one or more sensors further comprise a center-mounted LIDAR positioned below the rail, wherein the center-mounted LIDAR defines a downwardly angled field-of-view.

15. The system according to claim 14, wherein the center-mounted LIDAR is a short-range LIDAR sensor.

16. The system according to claim 15, wherein the first LIDAR sensor and the second LIDAR sensor are long-range LIDAR sensors.

17. A method for supporting one or more sensors on a vehicle comprising:
attaching an internal frame structure to an inside of a hood behind a grille supported by the hood; and
attaching an external frame structure to the internal frame structure, where the external frame structure is positioned outside of the hood in front of the grille, wherein supports for the external frame structure extend through the grille and attach to the internal frame structure,
wherein the external frame structure supports the one or more sensors at a position providing a line-of-sight not visible from inside a passenger compartment of the vehicle.

18. The method according to claim 17, further comprising:
securing the internal frame structure to the inside of the hood by at least one anchor point positioned above the grille and at least one anchor point positioned below the grille,
wherein the at least one anchor point positioned above the grille comprises at least one upper bracket, wherein the at least one upper bracket is secured to the inside of the hood by an adhesive.

19. The method according to claim 17, wherein the internal frame structure comprises at least one vertical member and at least one horizontal member, wherein the at least one vertical member and the at least one horizontal member are connected via a tab-and-slot connection that is welded together.

20. The method according to claim 17, wherein the external frame structure includes a rail extending horizontally across a front of the hood, wherein two or more LIDAR sensors and at least one camera are secured to the rail.
